(19) United States
(12) Patent Application Publication
(10) Pub. No.: US 2026/0151930 A1
(43) Pub. Date: Jun. 4, 2026

(54) 1,3-PROPANEDIOL CARRIER COMPOSITIONS AND METHODS OF USE THEREOF

(71) Applicant: Primient Covation LLC, Loudon, TN (US)

(72) Inventor: David Lof, Vellinge (SE)

(73) Assignee: Primient Covation LLC, Loudon, TN (US)

(21) Appl. No.: 19/407,246

(22) Filed: Dec. 3, 2025

Related U.S. Application Data
(60) Provisional application No. 63/727,872, filed on Dec. 4, 2024.

(51) Int. Cl. B27K 3/22; B27K 3/02; B27K 3/52

(52) U.S. Cl. CPC B27K 3/22; B27K 3/0285; B27K 3/52

(57) ABSTRACT

Disclosed herein are penetration compositions comprising a 1,3-propanediol carrier and a binder or a copper-based wood penetration composition. The binder can be, e.g., sodium silicate, sodium carbonate, trisodium phosphate, potassium silicate, lithium silicate, magnesium silicate, calcium silicate, ammonium silicate, or a combination thereof. Also disclosed herein are methods of improving stability and penetration of binder into a substrate comprising impregnating the substrate with the presently disclosed penetration compositions.

### CROSS-REFERENCE TO RELATED APPLICATIONS

This application claims the benefit of U.S. Provisional Application No. 63/727,872, filed Dec. 4, 2024, which is incorporated herein, in its entirety, by reference.

### FIELD

The present disclosure relates to impregnation of substrates with a 1,3-propanediol carrier and a binder.

### BACKGROUND

Water/aqueous based impregnation techniques depend largely on controlled swelling of the substrate during an energy intensive process including high temperature and pressure over time. Common drawbacks are limited penetration of the impregnation liquid, discoloring, stability, and to some extent swelling of the impregnated substrate.

The binder liquid sodium silicate (water glass) penetrates the interiors of porous materials altering cellular structures and forming many microscopically thin glassy layers. Such binders enhance the physical properties of substrates, such as dimensional stability, hardness, decay resistance, and fire resistance.

There remains a need, however, to increase the stability and penetrability of binders into substrates. Water glass tends to create instability in any kind of system, and it can be difficult to combine with some binders.

There is therefore a demand for improving the properties in substrates in several areas, e.g., water resistance, improved hardness, dimension stability, mechanical strength, stiffness, and colorization.

### SUMMARY

One aspect is for a wood penetration composition comprising about 1.0 wt % to about 15 wt % 1,3-propanediol and a copper-based wood penetration formulation. In some embodiments, the copper-based wood penetration formulation comprises copper naphthenate, copper 8-quinolinolate, acid copper chromate, alkaline copper quaternary composition containing copper oxide and a quaternary ammonium compound, bis-(N-cyclohexyldiazeniumdioxy)-copper, chromated copper arsenate, or micronized copper.

Another aspect is for a method of improving penetration of a copper-based wood penetration formulation into wood comprising impregnating the wood with the aforementioned wood penetration composition.

A further aspect is for a stability composition comprising about 1.0 wt % to about 15 wt % 1,3-propanediol and sodium silicate. In some embodiments, the sodium silicate comprises sodium metasilicate, sodium orthosilicate, sodium pyrosilicate, or a combination thereof.

A further aspect is for a penetration composition comprising a 1,3-propanediol carrier and a binder. In some embodiments, the binder is sodium silicate, sodium carbonate, trisodium phosphate, potassium silicate, lithium silicate, magnesium silicate, calcium silicate, ammonium silicate, or a combination thereof. In some embodiments, the sodium silicate comprises sodium metasilicate, sodium orthosilicate, sodium pyrosilicate, or a combination thereof.

An additional aspect is for a method of improving stability and penetration of binder into a substrate comprising impregnating the substrate with the aforementioned penetration composition. In some embodiments, the substrate is wood, concrete, a building composite, or a construction composite; and in some embodiments, building composite or the construction composite is composite wood, reinforced plastic, a ceramic matrix composite, or a metal matrix composite.

A further aspect is for a stability composition comprising a 1,3-propanediol carrier and a binder. In some embodiments, the binder is sodium silicate, sodium carbonate, trisodium phosphate, potassium silicate, lithium silicate, magnesium silicate, calcium silicate, ammonium silicate, or a combination thereof. In some embodiments, the sodium silicate comprises sodium metasilicate, sodium orthosilicate, sodium pyrosilicate, or a combination thereof.

Other objects and advantages will become apparent to those skilled in the art upon reference to the detailed description that hereinafter follows.

### BRIEF DESCRIPTION OF THE DRAWINGS

FIG. 1A shows uptake of water glass in scooth pine (sapwood) wood without use of 1,3-propanediol carrier. FIG. 1B shows uptake of water glass in scooth pine wood with use of 1.0 wt % 1,3-propanediol carrier.

FIG. 2 shows transparency of waterglass with a 1,3-propanediol carrier.

FIG. 3 shows wood vacuum-pressure impregnated in 15% water glass solution.

### DETAILED DESCRIPTION

Applicant has solved the stated problem. 1,3-propanediol, when used a carrier for a substrate binder, improves the stability and/or penetrability of a binder into a substrate.

### Definitions

Applicant specifically incorporates the entire contents of all cited references in this disclosure. Further, when an amount, concentration, or other value or parameter is given as either a range or a list of upper values and lower values, this is to be understood as specifically disclosing all ranges formed from any pair of any upper range limit or value and any lower range limit or value, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

The indefinite articles “a” and “an”, as used herein in the specification and in the claims, unless clearly indicated to the contrary, should be understood to mean “at least one”.

The phrase “and/or”, as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B”, when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of”, or, when used in the claims, “consisting of”, will refer to the inclusion of exactly one element of a number or list of elements. In general, the term “or” as used herein shall only be interpreted as indicating exclusive alternatives (i.e., “one or the other but not both”) when preceded by terms of exclusivity, “either”, “one of”, “only one of”, “exactly one of”. “Consisting essentially of”, when used in the claims, shall have its ordinary meaning as used in the field of patent law.

The term “about” as used herein when referring to a measurable value such as an amount, a temporal duration, and the like, is meant to encompass variations of ±20%, ±10%, ±5%, ±1%, or ±0.1% from the specified value, as such variations are appropriate to perform the disclosed methods.

The term “anthropogenic” means man-made or fossil-derived.

“Carbon of atmospheric origin” as used herein refers to carbon atoms from carbon dioxide molecules that have recently, in the last few decades, been free in the earth's atmosphere. Such carbons in mass are identifiable by the presence of particular radioisotopes as described herein. “Green carbon”, “atmospheric carbon”, “environmentally friendly carbon”, “life-cycle carbon”, “non-fossil fuel based carbon”, “non-petroleum based carbon”, “carbon of atmospheric origin”, and “biobased carbon” are used synonymously herein.

“Carbon of fossil origin” as used herein refers to carbon of petrochemical origin.

Such carbon has not been exposed to UV rays as atmospheric carbon has, therefore masses of carbon of fossil origin has few radioisotopes in their population. Carbon of fossil origin is identifiable by means described herein. “Fossil fuel carbon”, “fossil carbon”, “polluting carbon”, “petrochemical carbon”, “petro-carbon” and carbon of fossil origin are used synonymously herein.

The abbreviation “IRMS” refers to measurements of CO₂ by high precision stable isotope ratio mass spectrometry.

The term “carbon substrate” means any carbon source capable of being metabolized by a microorganism wherein the substrate contains at least one carbon atom.

“Renewably-based” denotes that the carbon content of the 1,3-propanediol is from a “new carbon” source as measured by ASTM test method D 6866-05 Determining the Biobased Content of Natural Range Materials Using Radiocarbon and Isotope Ratio Mass Spectrometry Analysis, incorporated herein by reference. This test method measures the C-14/C-12 isotope ratio in a sample and compares it to the C-14/C-12 isotope ratio in a standard 100% biobased material to give percent biobased content of the sample. “Biobased materials” are organic materials in which the carbon comes from recently (on a human time scale) fixated CO₂ present in the atmosphere using sunlight energy (photosynthesis). On land, this CO₂ is captured or fixated by plant life (e.g., agricultural crops or forestry materials). In the oceans, the CO₂ is captured or fixated by photosynthesizing bacteria or phytoplankton. A biobased material has a C-14/C-12 isotope ratio in range of from 1:0 to greater than 0:1. Contrarily, a fossil-based material, has a C-14/C-12 isotope ratio of 0:1.

A “b*” value is the spectrophotometrically determined “Yellow Blue” measurement as defined by the CIE L*a*b* measurement ASTM D6290.

By the terms “color” and “color bodies” is meant the existence of visible color that can be quantified using a spectrocolorimeter in the range of visible light, using wavelengths of approximately 400-800 nm, and by comparison with pure water. Reaction conditions can have an important effect on the nature of color production. Examples of relevant conditions include the temperatures used, the catalyst and amount of catalyst. While not wishing to be bound by theory, color precursors are believed to include trace amounts of impurities comprising olefinic bonds, acetals and other carbonyl compounds, peroxides, etc. At least some of these impurities may be detected by such methods as UV spectroscopy, or peroxide titration.

The term “biodegradable” means the capacity of a composition or compound to be broken down by living organisms to simple, stable compounds such as carbon dioxide and water in a relatively short time, e.g., less than years or months, as opposed to plastics.

An “anthropogenic emission profile” means anthropogenic CO₂ emissions that are contributed to the atmosphere upon biodegradation of a compound or composition.

The abbreviation “AMS” refers to accelerator mass spectrometry.

By the acronym “NMR” is meant nuclear magnetic resonance.

“Color index” refers to an analytic measure of the electromagnetic radiation-absorbing properties of a substance or compound.

“Biologically-produced” means organic compounds produced by one or more species or strains of living organisms, including particularly strains of bacteria, yeast, fungus and other microbes. “Bio-produced” and Biologically-produced are used synonymously herein. Such organic compounds are composed of carbon from atmospheric carbon dioxide converted to sugars and starches by green plants.

“Biologically-derived” means that the organic compound is synthesized from biologically produced organic components. “Biologically-derived”, and “bio-derived,” “biologically-based,” “bio-based”, and “bio-sourced” are used synonymously herein.

The term “porous wood product” refers to engineered wood products, which are composite materials manufactured by binding or fixing the strands, particles, fibers, or boards of woods together with some method of fixation. Such porous wood products cab be prepared from any wood pieces such as sheets, chips, flakes, fibers, strands (e.g., rectangular-shaped wood strands), saw dust, and the like.

The term “fiberboard” refers to a type of engineered wood product that is made out of wood fibers. Typically, fiberboard is a building material composed of wood chips or plant fibers bonded together and compressed into rigid sheets.

### Penetration Composition

Some embodiments are directed to penetration compositions comprising a 1,3-propanediol carrier and a binder. “1,3-propanediol” or “PDO” refers to either chemically- or biologically-produced 1,3-propanediol. The terms “biologically-produced 1,3-propanediol”, “bioPDO”, “biologically-produced, biodegradable 1,3-propanediol”, “renewably-based 1,3-propanediol”, “renewably-based, biodegradable 1,3-propanediol,” “biosourced,” and “biologically-produced 1,3-propanediol” and similar terms as used herein refer to 1,3-propanediol derived from microorganism metabolism of plant-derived sugars composed of carbon of atmospheric origin, and not composed of fossil-fuel carbon.

When selecting products, consumers consider product safety, environmental impact, the extent to which the components are natural, and the aesthetic quality of the overall product. Biologically-produced 1,3-propanediol (e.g., Zemea® Propanediol by DuPont Tate & Lyle) is well suited to meet these consumer demands. High-purity 1,3-propanediol can be obtained from fermentation-based processes for incorporation into compositions. It has less environmental impact than synthetically produced glycols, because biodegradation of biologically-produced 1,3-propanediol contributes no anthropogenic CO₂ emissions to the atmosphere.

In some embodiments, the 1,3-propanediol can be biologically-produced 1,3-propanediol, chemically-produced 1,3-propanediol, or a combination thereof.

Advantageously, biologically-produced 1,3-propanediol can be biodegradable and can have an anthropogenic CO₂ emission profile of zero (0).

Whereas photosynthesis is the process of creating growing matter through the conversion of carbon dioxide (CO₂) and water (H₂O) into plant material through the action of the sun, biodegradation is the process of converting organic material back into CO₂ and H₂O through the activity of living organisms. There are many published test methods for measuring the biodegradability of organic chemicals such as glycols. One internationally recognized method is ASTM E1720-01, Standard Test Method for Determining Ready, Ultimate Biodegradability of Organic Chemicals in a Sealed Vessel CO₂ Production Test. Chemicals that demonstrate 60% biodegradation or better in this test method will biodegrade in most aerobic environments and are classified as ready biodegradable. All of the glycols referred to in this document meet this criterion.

Glycols such as ethylene glycol, propylene glycol, 1,3-butylene glycol, and 2-methyl-1,3-propanediol are biodegradable compounds useful in compositions ranging from cosmetics and personal care formulations to detergents to heat transfer compositions. While biodegradability is an important factor in protecting the environment, biodegradation of glycols derived from fossil-based sources has the unavoidable consequence of releasing previously fixed CO₂ into the atmosphere. Thus, while glycols in general are advantageous for their biodegradability, the resulting global warming potential of fossil-based glycols during biodegradation is significant.

Carbon dioxide is singled out as the largest component of the collection of greenhouse gases in the atmosphere. The level of atmospheric carbon dioxide has increased 50% in the last two hundred years. Recent reports indicate that the current level of atmospheric carbon dioxide is higher than the peak level in the late Pleistocene, the epoch before modern humans (Siegenthaler, U. et al. Stable Carbon Cycle-Climate Relationship During the Late Pleistocene, Science, Vol. 310, no. 5752 (Nov. 25, 2005), pp. 1313-1317). Therefore, any further addition of carbon dioxide to the atmosphere is thought to further shift the effect of greenhouse gases from stabilization of global temperatures to that of heating. Consumers and environmental protection groups alike have identified industrial release of carbon into the atmosphere as the source of carbon causing the greenhouse effect.

Greenhouse gas emission can occur at any point during the lifetime of a product. Consumers and environmental groups consider the full lifespan of a product when evaluating a product's environmental impact. Consumers look for products that do not contribute new carbon to the atmosphere considering the environmental impact of production, use and degradation. Only organic products composed of carbon molecules from plant sugars and starches and ultimately atmospheric carbon are considered to not further contribute to the greenhouse effect.

In addition to adding carbon dioxide to the atmosphere, current methods of industrial production of glycols produce contaminants and waste products that include among them sulfuric acid, hydrochloric acid, hydrofluoric acid, phosphoric acid, oxalic acid tartaric acid, acetic acids, Alkali metals, alkaline earth metals, transitional metals and heavy metals, including iron, cobalt, nickel, copper, silver, molybdenum, tungsten, vanadium, chromium, rhodium, palladium, osmium, iridium, rubidium, and platinum (U.S. Pat. Nos. 2,434,110, 5,034,134, and 5,334,778).

Calculations setting forth the finding that the 1,3-propanediol disclosed herein provides no anthropogenic CO₂ emissions upon biodegradation is set forth below. When one molecule of 1,3-propanediol degrades, three molecules of CO₂ are released into the atmosphere. Because all of these molecules of CO₂ released during degradation from “fermentatively-derived” 1,3-propanediol have an atmospheric origin, the net release of CO₂ to the atmosphere is thus zero. Comparatively, because a fossil fuel-derived propylene glycol and fossil-derived 1,3-propanediol contains three carbon atoms which originate from a fixed carbon source (i.e., the fossil fuel), degradation of one molecule of fossil fuel-derived propylene glycol or 1,3-propanediol results in a net release of three molecules of CO₂ into the atmosphere. Similarly, because fossil fuel-derived ethylene glycol contains two carbon atoms, which originate from a fixed carbon source, degradation of one molecule of fossil fuel-derived ethylene glycol results in a net release of two molecules of CO₂ into the atmosphere.

In order to quantify the CO₂ released for one kilogram of each ethylene glycol, propylene glycol, chemical 1,3-propanediol and “fermentatively-derived” 1,3 propanediol (Bio-PDO™), the product weight (1 kg) is divided by its molecular weight. For each carbon atom present in the molecule, one molecule of CO₂ is released. The molecules of CO₂ are multiplied by the molecular weight of CO₂ (44 kg/kmole) to quantify the impact of CO₂ release (kg) per one unit (kg) of product.

$$Fossil Fuel Derived Ethylene Glycol ( EG )$$

$$1 kg EG ( \frac{1 kmol EG}{62.0 \; 68 kg EG} ) ( \frac{2 kmol {CO}_{2}}{1 kmol EG} ) ( \frac{44 kg {CO}_{2}}{1 kmol {CO}_{2}} ) = 1.4 kg {CO}_{2}$$

$$Fossil Fuel Derived Propylene Glycol ( PG )$$

$$1 kg PG ( \frac{1 kmol PG}{76.0 \; 94 kg PG} ) ( \frac{3 kmol {CO}_{2}}{1 kmol PG} ) ( \frac{44 kg {CO}_{2}}{1 kmol {CO}_{2}} ) = 1.7 kg {CO}_{2}$$

$$Fossil Fuel Derived 1 , 3 - Propanediol ( PDO )$$

$$1 kg PDO ( \frac{1 kmol PDO}{76.0 \; 94 kg PDO} ) ( \frac{3 kmol {CO}_{2}}{1 kmol PDO} ) ( \frac{44 kg {CO}_{2}}{1 kmol {CO}_{2}} ) = 1.7 kg {CO}_{2}$$

### Biologically-Produced 1,3-Propanediol (Bio-PDO™) Carbon Feedstock Balance

### Capture:

$$1 kg Bio - PD {O}^{TM} ( \frac{1 kmol Bio - PD {O}^{TM}}{76.0 \; 94 kg Bio - PD {O}^{TM}} ) ( \frac{- 3 kmol {CO}_{2}}{1 kmol Bio - PD {O}^{TM}} ) ( \frac{44 kg {CO}_{2}}{1 kmol {CO}_{2}} ) = - 1.7 kg {CO}_{2}$$

### Release:

$$1 kg Bio - {PDO}^{TM} ( \frac{1 kmol Bio - {PDO}^{TM}}{76.0 \; 94 kg Bio - {PDO}^{TM}} ) ( \frac{3 kmol {CO}_{2}}{1 kmol Bio - {PDO}^{TM}} ) ( \frac{44 kg {CO}_{2}}{1 kmol {CO}_{2}} ) = 1.7 kg {CO}_{2}$$

### Net:

$$- 1.7 kg {CO}_{2} + 1.7 kg {CO}_{2} = 0 kg {CO}_{2}$$

This Biologically-produced 1,3-Propanediol Carbon Feedstock Balance result demonstrates that there are no anthropogenic CO₂ emissions from the biodegradation of the renewably sourced biologically-produced 1,3-propanediol.

A small amount of the carbon dioxide in the atmosphere is radioactive. This 14C carbon dioxide is created when nitrogen is struck by an ultra-violet light produced neutron, causing the nitrogen to lose a proton and form carbon of molecular weight 14 which is immediately oxidized in carbon dioxide. This radioactive isotope represents a small but measurable fraction of atmospheric carbon. Atmospheric carbon dioxide is cycled by green plants to make organic molecules during the process known as photosynthesis. The cycle is completed when the green plants or other forms of life metabolize the organic molecules producing carbon dioxide which is released back to the atmosphere. Virtually all forms of life on Earth depend on this green plant production of organic molecule to produce the chemical energy that facilitates growth and reproduction. Therefore, the 14C that exists in the atmosphere becomes part of all life forms, and their biological products. These renewably based organic molecules that biodegrade to CO₂ do not contribute to global warming as there is no net increase of carbon emitted to the atmosphere. In contrast, fossil fuel based carbon does not have the signature radiocarbon ratio of atmospheric carbon dioxide.

Atmospheric origin and fixed carbon source as used herein are relative terms in that the time period of when CO₂ is of atmospheric or fixed origin relates to the life cycle of the 1,3-propanediol. Thus, while it is quite possible that, at one time, carbon from a fossil fuel was found in the atmosphere (and, as a corollary, that atmospheric CO₂ may one day be incorporated into a fixed carbon source), for purposes herein carbon is considered to be from a fixed carbon source until it is released into the atmosphere by degradation.

Assessment of the renewably based carbon in a material can be performed through standard test methods. Using radiocarbon and isotope ratio mass spectrometry analysis, the biobased content of materials can be determined. ASTM International, formally known as the American Society for Testing and Materials, has established a standard method for assessing the biobased content of materials. The ASTM method is designated ASTM-D6866.

The application of ASTM-D6866 to derive a “biobased content” is built on the same concepts as radiocarbon dating, but without use of the age equations. The analysis is performed by deriving a ratio of the amount of radiocarbon (14C) in an unknown sample to that of a modem reference standard. The ratio is reported as a percentage with the units “pMC” (percent modern carbon). If the material being analyzed is a mixture of present day radiocarbon and fossil carbon (containing no radiocarbon), then the pMC value obtained correlates directly to the amount of biomass material present in the sample.

The modern reference standard used in radiocarbon dating is a NIST (National Institute of Standards and Technology) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC.

Bomb carbon in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn could give a radiocarbon signature near 107.5 pMC.

Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, it would give a radiocarbon signature near 54 pMC.

A biomass content result is derived by assigning 100% equal to 107.5 pMC and 0% equal to 0 pMC. In this regard, a sample measuring 99 pMC will give an equivalent biobased content result of 93%.

A sample of “fermentatively-derived” 1,3-propanediol was submitted by DuPont to Iowa State University for biobased content analysis using ASTM method D 6866-05. The results received from Iowa State University demonstrated that the above sample was 100% bio-based content (ref: Norton, Glenn. Results of Radiocarbon Analyses on samples from DuPont Bio-Based Materials—reported Jul. 8, 2005).

Assessment of the materials described herein were done in accordance with ASTM-D6866. The mean values quoted in this report encompass an absolute range of 6% (plus and minus 3% on either side of the biobased content value) to account for variations in end-component radiocarbon signatures. It is presumed that all materials are present day or fossil in origin and that the desired result is the amount of biobased component “present” in the material, not the amount of biobased material “used” in the manufacturing process.

There may be certain instances wherein a combination of a biologically-produced 1,3-propanediol and one or more non biologically-produced glycol components, such as, for example, chemically synthesized 1,3-propanediol may be included in a composition. In such compositions, it may be difficult, if not impossible, to determine which percentage of the glycol composition is biologically-produced, other than by calculating the bio-based carbon content of the glycol component. In this regard, in the compositions, the glycol component, and in particular, the 1,3-propanediol, can comprise at least about 1% bio-based carbon content up to 100% bio-based carbon content, and any percentage therebetween. For example, a composition may include 1,3-propanediol that has at least 5%, at least 10%, at least 25%, at least 50%, at least 75%, at least 90%, at least 99%, or 100% biobased carbon. In one embodiment, the 1,3-propanediol comprises substantially all of the glycol component of the composition. In another embodiment, the 1,3-propanediol comprises all of the glycol component of the composition. Compositions that have a bio-based carbon content of at least 1% have a lower anthropogenic CO₂ emission profile as compared to a composition comprising 1,3-propanediol with a bio-based carbon content of 0%.

Consumers seek products that are composed of additives of a more purified source and/or of all natural composition. Also of concern to consumers, is among other things, an individual's reaction to such a product. The rate of development of hypersensitivity has markedly increased in the US in the last two decades. Many of these reactions are attributed to trace amount of substances. Other reactions are of idiopathic origin.

In one embodiment, the biologically-produced 1,3-propanediol of the present disclosure can be substantially purified. “Substantially purified,” as used herein, denotes a composition comprising 1,3-propanediol having one or more of the following characteristics: (1) an ultraviolet absorption at 220 nm of less than about 0.200 and at 250 nm of less than about 0.075 and at 275 nm of less than about 0.075 absorbance units using a one centimeter path length and dilution of the 1,3-propanediol in a 1 to 5 dilution with glass-distilled water; (2) a composition having L*a*b* “b*” color value of less than about 0.15 and an absorbance at 270 nm of less than about 0.075 absorbance units using a one centimeter path length and dilution of the 1,3-propanediol in a 1 to 5 dilution with glass-distilled water; (3) a peroxide composition of less than about 200, 150, 100, 50, 40, 30, 20, 10, 5, 1 or about 0.5 ppm; and (4) a concentration of total organic impurities of less than about 1,000, 900, 800, 700, 600, 500, 400, 300, 200, 150, 100, 50 or about 10 ppm. Any of these sets of values can be used to define a range, such as a peroxide composition of about 0.5 ppm to about 200 ppm, about 1 ppm to about 150 ppm, about 5 ppm to about 100 ppm, about 10 ppm to about 50 ppm, or about 20 ppm to about 40 ppm. The concentration of total organic impurities may range from about 10 ppm to about 1,000 ppm, about 50 ppm to about 900 ppm, about 100 ppm to about 800 ppm, about 150 ppm to about 700 ppm, about 200 ppm to about 600 ppm, or about 300 ppm to about 500 ppm.

The peroxide composition in ppm and total organic impurities can be determined by standard analytical techniques, including gas chromatography.

It is believed that the aforementioned purity level parameters for biologically-produced and purified 1,3-propanediol distinguishes such compositions from 1,3-propanediol compositions prepared from chemically purified 1,3-propanediol derived from petroleum sources and/or from biologically purified 1,3-propanediol not exhibiting such purity values.

It is believed that the aforementioned purity level parameters for biologically-produced and purified 1,3-propanediol (using methods similar or comparable to those disclosed in U.S. Patent Application No. 2005/0069997) distinguishes such compositions from 1,3-propanediol compositions prepared from chemically purified 1,3-propanediol derived from petroleum sources.

In some embodiments, extracts of a glycol or glycols (in some embodiments, 1,3-propanediol) may be used in any purity percentage (e.g., about 25% to 100%, and any increment range described therein in increments of 0.5%). In another embodiment, when a glycol is used as a non-extract, the purity of the glycol can be about 25% to 100%, and any increment range described therein in increments of 0.5%. According to other embodiments, the purity of the glycol (extract or non-extract) can be about 50% to 100%, about 70% to 100%, about 80% to 100%, about 90% to 100%; about 95% to 100%, about 95% to 99.5%, about 96% to 100%, about 97% to 100%, about 98% to 100%, or about 99% to 100%. According to particular embodiments, the purity of a 1,3-propanediol can be about 50% to 100%, about 70% to 100%, about 80% to 100%, about 90% to 100%, about 95% to 100%, about 95% to 99.5%, about 96% to 100%, about 97% to 100%, about 98% to 100%, or about 99% to 100%.

In one embodiment, biologically-produced 1,3-propanediol can be obtained based upon use of the fermentation broth (“fermentatively-derived”) generated by a genetically-engineered Escherichia coli (E. coli) previously disclosed in, for example, U.S. Pat. No. 5,686,276. In other embodiments, one or more single organisms, or combinations of organisms, may be used to biologically produce 1,3-propanediol, using organisms that have been genetically-engineered according to methods known in the art. “Fermentation” refers to a system that catalyzes a reaction between substrate(s) and other nutrients to product(s) through use of a biocatalyst. The biocatalysts can be a whole organism, an isolated enzyme, or any combination or component thereof that is enzymatically active. Fermentation systems useful for producing and purifying biologically-produced 1,3-propanediol are disclosed in, for example, U.S. Pat. No. 7,919,658 incorporated herein by reference.

1,3-propanediol as used herein can also be produced by chemical routes. For example, 1,3-propanediol can be produced by the hydration of acrolein. The process generally involves effecting the simultaneous hydration and condensation of acrolein, preferably in the presence of a hydration catalyst such as dilute sulfuric acid, followed by the catalytic hydrogenation of one or more of the organic constituents of the reaction mixture, such constituents comprising hydracyrlic aldehyde, unreacted acrolein, and their polymerization and condensation products. The condensation step, which again may be accompanied by condensation, produces among other products 1,3-propanediol.

An alternative route involves the hydroformylation of ethylene oxide to afford 3-hydroxypropionaldehyde. Generally, this process for synthesizing 1,3-propanediol comprises intimately contacting ethylene oxide, carbon monoxide and hydrogen (syngas), and a bimetallic catalyst in a liquid-phase solution in an inert reaction solvent at a temperature of from about 30 to 150° C., and an elevated pressure, preferably 100 to 4000 psi.

In some embodiments, the amount of 1,3-propanediol carrier in the penetration composition is in a range of about 1.0 wt % to about 15 wt %, about 1.25 wt % to about 15 wt %, about 1.5 wt % to about 15 wt %, about 1.75 wt % to about 15 wt %, about 2 wt % to about 15 wt %, about 2.25 wt % to about 15 wt %, about 2.5 wt % to about 15 wt %, about 2.75 wt % to about 15 wt %, about 3 wt % to about 15 wt %, about 3.25 wt % to about 15 wt %, about 3.5 wt % to about 15 wt %, about 3.75 wt % to about 15 wt %, about 4 wt % to about 15 wt %, about 4.25 wt % to about 15 wt %, about 4.5 wt % to about 15 wt %, about 4.75 wt % to about 15 wt %, about 5 wt % to about 15 wt %, about 5.25 wt % to about 15 wt %, about 5.5 wt % to about 15 wt %, about 5.75 wt % to about 15 wt %, about 6 wt % to about 15 wt %, about 6.25 wt % to about 15 wt %, about 6.5 wt % to about 15 wt %, about 6.75 wt % to about 15 wt %, about 7 wt % to about 15 wt %, about 7.25 wt % to about 15 wt %, about 7.5 wt % to about 15 wt %, about 7.75 wt % to about 15 wt %, about 8 wt % to about 15 wt %, about 8.25 wt % to about 15 wt %, about 8.5 wt % to about 15 wt %, about 8.75 wt % to about 15 wt %, about 9 wt % to about 15 wt %, about 9.25 wt % to about 15 wt %, about 9.5 wt % to about 15 wt %, about 9.75 wt % to about 15 wt %, about 10 wt % to about 15 wt %, about 10.25 wt % to about 15 wt %, about 10.5 wt % to about 15 wt %, about 10.75 wt % to about 15 wt %, about 11 wt % to about 15 wt %, about 11.25 wt % to about 15 wt %, about 11.5 wt % to about 15 wt %, about 11.75 wt % to about 15 wt %, about 12 wt % to about 15 wt %, about 12.25 wt % to about 15 wt %, about 12.5 wt % to about 15 wt %, about 12.75 wt % to about 15 wt %, about 13 wt % to about 15 wt %, about 13.25 wt % to about 15 wt %, about 13.5 wt % to about 15 wt %, about 13.75 wt % to about 15 wt %, about 14 wt % to about 15 wt %, about 14.25 wt % to about 15 wt %, about 14.5 wt % to about 15 wt %, about 14.75 wt % to about 15 wt %, about 1.0 wt % to about 14.75 wt %, about 1.0 wt % to about 14.5 wt %, about 1.0 wt % to about 14.25 wt %, about 1.0 wt % to about 14 wt %, about 1.0 wt % to about 13.75 wt %, about 1.0 wt % to about 13.5 wt %, about 1.0 wt % to about 13.25 wt %, about 1.0 wt % to about 13 wt %, about 1.0 wt % to about 12.75 wt %, about 1.0 wt % to about 12.5 wt %, about 1.0 wt % to about 12.25 wt %, about 1.0 wt % to about 12 wt %, about 1.0 wt % to about 11.75 wt %, about 1.0 wt % to about 11.5 wt %, about 1.0 wt % to about 11.25 wt %, about 1.0 wt % to about 11 wt %, about 1.0 wt % to about 10.75 wt %, about 1.0 wt % to about 10.5 wt %, about 1.0 wt % to about 10.25 wt %, about 1.0 wt % to about 10 wt %, about 1.0 wt % to about 9.75 wt %, about 1.0 wt % to about 9.5 wt %, about 1.0 wt % to about 9.5 wt %, about 1.0 wt % to about 9.25 wt %, about 1.0 wt % to about 9 wt %, about 1.0 wt % to about 8.75 wt %, about 1.0 wt % to about 8.5 wt %, about 1.0 wt % to about 8.25 wt %, about 1.0 wt % to about 8 wt %, about 1.0 wt % to about 7.75 wt %, about 1.0 wt % to about 7.5 wt %, about 1.0 wt % to about 7.25 wt %, about 1.0 wt % to about 7 wt %, about 1.0 wt % to about 6.75 wt %, about 1.0 wt % to about 6.5 wt %, about 1.0 wt % to about 6.25 wt %, about 1.0 wt % to about 6 wt %, about 1.0 wt % to about 5.75 wt %, about 1.0 wt % to about 5.5 wt %, about 1.0 wt % to about 5.25 wt %, about 1.0 wt % to about 5 wt %, about 1.0 wt % to about 4.75 wt %, about 1.0 wt % to about 4.5 wt %, about 1.0 wt % to about 4.25 wt %, about 1.0 wt % to about 4 wt %, about 1.0 wt % to about 3.75 wt %, about 1.0 wt % to about 3.5 wt %, about 1.0 wt % to about 3.25 wt %, about 1.0 wt % to about 3 wt %, about 1.0 wt % to about 2.75 wt %, about 1.0 wt % to about 2.5 wt %, about 1.0 wt % to about 2.25 wt %, about 1.0 wt % to about 2 wt %, about 1.0 wt % to about 1.75 wt %, about 1.0 wt % to about 1.5 wt %, about 1.0 wt % to about 1.25 wt %, about 1.5 wt % to about 14.5 wt %, about 2.0 wt % to about 14.0 wt %, about 2.5 wt % to about 13.5 wt %, about 3.0 wt % to about 13.0 wt %, about 3.5 wt % to about 12.5 wt %, about 4.0 wt % to about 12.0 wt %, about 4.5 wt % to about 11.5 wt %, about 5.0 wt % to about 11.0 wt %, about 5.5 wt % to about 10.5 wt %, about 6.0 wt % to about 10.0 wt %, about 6.5 wt % to about 9.5 wt %, about 7.0 wt % to about 9.0 wt %, or about 7.5 wt % to about 8.5 wt % of the total weight of the penetration composition. In some embodiments, the amount of 1,3-propanediol carrier in the penetration composition is about 1.0 wt %, about 1.25 wt %, about 1.5 wt %, about 1.75 wt %, about 2 wt %, about 2.25 wt %, about 2.5 wt %, about 2.75 wt %, about 3 wt %, about 3.25 wt %, about 3.5 wt %, about 3.75 wt %, about 4 wt %, about 4.25 wt %, about 4.5 wt %, about 4.75 wt %, about 5 wt %, about 5.25 wt %, about 5.5 wt %, about 5.75 wt %, about 6 wt %, about 6.25 wt %, about 6.5 wt %, about 6.75 wt %, about 7 wt %, about 7.25 wt %, about 7.5 wt %, about 7.75 wt %, about 8 wt %, about 8.25 wt %, about 8.5 wt %, about 8.75 wt %, about 9 wt %, about 9.25 wt %, about 9.5 wt %, about 9.75 wt % about 10 wt %, about 10.25 wt %, about 10.5 wt %, about 10.75 wt %, about 11 wt %, about 11.25 wt %, about 11.5 wt %, about 11.75 wt % about 12 wt %, about 12.25 wt %, about 12.5 wt %, about 12.75 wt %, about 13 wt %, about 13.25 wt %, about 13.5 wt %, about 13.75 wt %, about 14 wt %, about 14.25 wt %, about 14.5 wt %, about 14.75 wt %, or about 15 wt % of the total weight of the penetration composition.

The penetration composition further comprises a binder that can seal porous substrates. In some embodiments, the binder is sodium silicate, sodium carbonate, trisodium phosphate, potassium silicate, lithium silicate, magnesium silicate, calcium silicate, ammonium silicate, or a combination thereof. In some embodiments, the sodium silicate comprises sodium metasilicate, sodium orthosilicate, sodium pyrosilicate, or a combination thereof. In some embodiments, the binder is tetraethyl orthosilicate, tetramethyl orthosilicate, methyltrimethoxysilane, ethyltrimethoxysilane, methyltriethoxysilane, ethyltriethoxysilane, 3-aminopropyltriethoxysilane, or trimethylchlorosilane. In some embodiments, the binder is fumed silica, a silica hydrosol, a reactive amorphous solid silica, a silica gel, silicic acid, sodium metasilicate hydrate, sesquisilicate, disilicate, colloidal silica, pyrogenic silica, a silicic acid ester, or a tetraalkoxysilane.

In some embodiments, 1,3-propanediol can be used as a stabilizer to one of the aforementioned binders.

In some embodiments where sodium silicate is used as the binder, the binder can be water glass of No. 1, No. 2, or No. 3 (sodium silicate aqueous solution) or the binder can be sodium metasilicate No. 1 or No. 2 (crystal).

Silica precursor(s) can be selected from tetraalkoxysilanes (e.g., TMOS, TEOS, and the like) (e.g., C₁-C₈alkoxy tetraalkoxysilanes), alkyltrialkoxysilanes (e.g., methyltrimethoxysilane (MTMS) and the like) (e.g., C₁-C₈alkyl, C₁-C₈alkoxy alkyltrialkoxysilanes), sodium metasilicates (e.g., water glass), and combinations thereof.

In some embodiments, the sodium metasilicate is sodium metasilicate pentahydrate, sodium metasilicate nonahydrate, or potassium metasilicate pentahydrate.

The binder can be present in the present penetration composition in a range of from about 0.1 wt % to about 99 wt %, 0.1 wt % to about 95 wt %, 0.1 wt % to about 90 wt %, 0.1 wt % to about 85 wt %, 0.1 wt % to about 80 wt %, 0.1 wt % to about 75 wt %, 0.1 wt % to about 70 wt %, 0.1 wt % to about 65 wt %, 0.1 wt % to about 60 wt %, 0.1 wt % to about 55 wt %, 0.1 wt % to about 50 wt %, 0.1 wt % to about 45 wt %, 0.1 wt % to about 40 wt %, 0.1 wt % to about 35 wt %, 0.1 wt % to about 30 wt %, 0.1 wt % to about 25 wt %, 0.1 wt % to about 20 wt %, 0.1 wt % to about 15 wt %, 0.1 wt % to about 10 wt %, or 0.1 wt % to about 5 wt % of the total weight of the penentration composition.

Some embodiments are directed to methods of improving stability and penetration of binder into a substrate comprising exposing the substrate to the aforementioned penetration composition. In some embodiments, the substrate is wood, concrete, a building composite, or a construction composite.

In some embodiments, the wood can be a hardwood with a fine porous wood interface such as, e.g., mahogany, oak, ash, hard maple, birch, or beech. In some embodiments, the wood can be a softwood, e.g., Douglas fir, eastern white pine, European spruce, larch, lodgepole pine, Monterey pine, Parana pine, Scots pine, Sitka spruce, southern yellow pine, western hemlock, western red cedar, or yew. Wood can relate to any wooden article or wooden parts, such as boards, beams, panels, veneers, frames, or construction elements.

In some embodiments, the wood is a porous wood product. In some embodiments, the porous wood product is a porous panel product such as medium-density fiberboard (MDF), high-density fiberboard (HDF), medium-density overlay (MDO), high-density overlay (HDO), oriented strand board (OSB), particleboard, chipboard, panel products, or plywood.

In some embodiments, the substrate is concrete, and in some embodiments, the concrete is normal strength concrete, plain concrete, lightweight concrete, ready mix concrete, polymer concrete, glass concrete, reinforced concrete, pervious concrete, prestressed concrete, precast concrete, air entrained concrete, high-strength concrete, vacuum concrete, asphalt concrete, rapid set concrete, or self-compacting concrete.

In some embodiments, the substrate is a building composite or a construction composite, and in some embodiments, the building composite or construction composite is composite wood, reinforced plastic, a ceramic matrix composite, or a metal matrix composite.

In some embodiments, the penetration composition can comprise optional components, e.g., copper. In some embodiments, the penetration composition may suitably include, within ranges that do not detract from the advantageous effects of the 1,3-propanediol carrier, various thickeners, pigments, dyes, penetrants, antistatic agents, antifoaming agents, flame retardants, antimicrobial agents, preservatives, crosslinking agents and adhesion promoters, and also other silicone oils, silicone resins, acrylic resins and urethane resins.

Copper-based wood penetration formulations are commonly used to pressure treat and preserve wood. The copper present in these formulations can be either solubilized copper solutions or dispersed particles of copper compounds/copper complexes and the copper or copper compound, acts as a biocide, fungicide, and insecticide, protecting wood pressure treated with the copper compounds against rot and decay caused by fungal, bacterial, and insect infestation.

In some embodiments, a solubilized copper compound is prepared from cuprous oxide, cupric oxide, copper hydroxide, copper carbonate, basic copper carbonate, copper oxychloride, copper metal, or copper borate; and a solubilizing agent. In certain embodiments, the solubilizing agent is an alkanolamine, such as, for example, monoethanolamine, ethanolamine, diethanolamine, triethanolamine or ammonia, and combinations thereof.

In some embodiments, the solid copper compound is prepared from cuprous oxide, cupric oxide, copper hydroxide, copper carbonate, basic copper carbonate, copper oxychloride, copper metal, or copper borate, and a dispersant or an emulsifier.

In some embodiments, the copper-based wood penetration formulation comprises a triazole. In some embodiments, the triazole is epoxiconazole, triadimenol, propiconazole, prothioconazole, metconazole, cyproconazole, tebuconazole, penflufen, flusilazole, paclobutrazol, fluconazole, isavuconazole, itraconazole, voriconazole, pramiconazole, ravuconazole, or posaconazole.

In some embodiments, the copper-based wood penetration formulation is a copper naphthenate (solvent-based), a copper 8-quinolinolate (water-based), an acid copper chromate, an alkaline copper quaternary composition containing copper oxide and a quaternary ammonium compound, a bis-(N-cyclohexyldiazeniumdioxy)-copper, a chromated copper arsenate, or a micronized copper formulation.

In some embodiments, the copper-based wood penetration formulation is present in the wood penetration composition in amount of about 0.01 wt %, about 0.05 wt %, about 0.10 wt %, about 0.15 wt %, about 0.20 wt %, about 0.25 wt %, about 0.30 wt %, about 0.35 wt %, about 0.40 wt %, about 0.45 wt %, about 0.50 wt %, about 0.55 wt %, about 0.60 wt %, about 0.65 wt %, about 0.70 wt %, about 0.75 wt %, about 0.80 wt %, about 0.85 wt %, about 0.90 wt %, about 0.95 wt %, about 1.00 wt %, about 1.25 wt %, about 1.50 wt %, about 1.75 wt %, about 2.00 wt %, about 2.25 wt %, about 2.50 wt %, about 2.75 wt %, about 3.00 wt %, about 3.25 wt %, about 3.50 wt %, about 3.75 wt %, about 4.00 wt %, about 4.25 wt %, about 4.50 wt %, about 4.75 wt %, about 5.00 wt %, about 5.25 wt %, about 5.50 wt %, about 5.75 wt %, about 6.00 wt %, about 6.25 wt %, about 6.50 wt %, about 6.75 wt %, about 7.00 wt %, about 7.25 wt %, about 7.50 wt %, about 7.75 wt %, about 8.00 wt %, about 8.25 wt %, about 8.50 wt %, about 8.75 wt %, about 9.00 wt %, about 9.25 wt %, about 9.50 wt %, about 9.75 wt %, or about 10.00 wt %. In some embodiments, the copper-based wood penetration formulation is present in the wood penetration composition in a range of from about 0.01 wt % to about 10.00 wt %, 0.25 wt % to about 10.00 wt %, 0.50 wt % to about 10.00 wt %, 0.75 wt % to about 10.00 wt %, 1.00 wt % to about 10.00 wt %, 1.50 wt % to about 10.00 wt %, 2.00 wt % to about 10.00 wt %, 2.50 wt % to about 10.00 wt %, 3.00 wt % to about 10.00 wt %, 3.50 wt % to about 10.00 wt %, 4.00 wt % to about 10.00 wt %, 4.50 wt % to about 10.00 wt %, 5.00 wt % to about 10.00 wt %, 5.50 wt % to about 10.00 wt %, 6.00 wt % to about 10.00 wt %, 6.50 wt % to about 10.00 wt %, 7.00 wt % to about 10.00 wt %, 7.50 wt % to about 10.00 wt %, 8.00 wt % to about 10.00 wt %, 8.50 wt % to about 10.00 wt %, 9.00 wt % to about 10.00 wt %, 9.50 wt % to about 10.00 wt %, 0.01 wt % to about 9.50 wt %, 0.01 wt % to about 9.00 wt %, 0.01 wt % to about 8.5 wt %, 0.01 wt % to about 8.00 wt %, 0.01 wt % to about 7.50 wt %, 0.01 wt % to about 7.00 wt %, 0.01 wt % to about 6.50 wt %, 0.01 wt % to about 6.00 wt %, 0.01 wt % to about 5.50 wt %, 0.01 wt % to about 5.00 wt %, 0.01 wt % to about 4.50 wt %, 0.01 wt % to about 4.00 wt %, 0.01 wt % to about 3.50 wt %, 0.01 wt % to about 3.00 wt %, 0.01 wt % to about 2.50 wt %, 0.01 wt % to about 2.00 wt %, 0.01 wt % to about 1.50 wt %, 0.01 wt % to about 1.00 wt %, 0.01 wt % to about 0.75 wt %, 0.01 wt % to about 0.50 wt %, or about 0.01 wt % to about 0.25 wt %.

The method for preparing the penetration composition is not particularly limited, so long as the above essential ingredients (1,3-propanediol and binder) and optional ingredients are mixed together.

The impregnation of a substrate with a penetration composition can be carried out by spraying, dipping, brushing, vacuum impregnation, or by vacuum-pressure impregnation. For vacuum impregnation, the vacuum used depends on the boiling point(s) of the solvent(s) of the penetration composition. In the case of vacuum-pressure impregnation, the pressure used depends on the equipment used for vacuum-pressure impregnation. Depending on the system, it is possible to use a pressure of typically up to 16 bar.

In some embodiments, the presently disclosed penetration compositions comprising a 1,3-propanediol carrier will improve the penetration of a binder into a substrate and/or the stability of the binder in the substrate. In some embodiments, penetration compositions comprising a 1,3-propanediol carrier improve the penetration of a binder into a substrate by at least about 5%, 10%, 15%, 20%, 25%, 30%, 35%, 40%, 45%, about 50%, about 55%, about 60%, about 65%, about 70%, about 75%, about 80%, about 85%, about 90%, about 95%, about 100% or more as compared to penetration of the binder without a 1,3-propanediol carrier. In some embodiments, penetration compositions comprising a 1,3-propanediol carrier improve the stability the binder in the substrate by at least about 5%, 10%, 15%, 20%, 25%, 30%, 35%, 40%, 45%, about 50%, about 55%, about 60%, about 65%, about 70%, about 75%, about 80%, about 85%, about 90%, about 95%, about 100% or more as compared to stability of the binder without a 1,3-propanediol carrier.

In some embodiments, copper penetration passing rate in a wood product contacted with a wood penetration composition is at least about 5% greater; or at least about 10% greater; or at least about 15% greater; or at least about 20% greater; or at least about 25% greater; or at least about 30% greater; or at least about 35% greater; or at least about 40% greater; or at least about 45% greater; or at least about 50% greater; or at least about 55% greater; or at least about 60% greater; or at least about 65% greater; at least about 70% greater; at least about 75% greater; at least about 80% greater than the copper penetration passing rate of a wood product treated with a copper-based wood penetration formulation lacking 1,3-propanediol.

### EXAMPLES

### Example 1

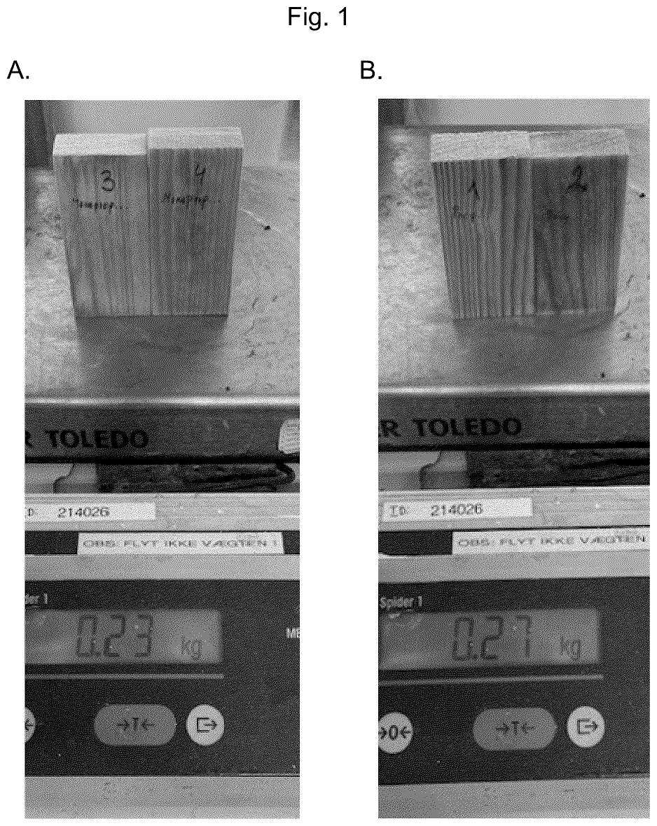

Vacuum-pressure impregnation was used to impregnate Scooth pine (sapwood) wood with monopropylene glycol (FIG. 1A) or 1.0 wt % 1,3-propanediol (FIG. 1B). All wood samples were fully immersed in either monopropylene glycol or 1,3-propanediol.

Immersion in 1,3-propanediol reveals wood penetration as compared to monopropylene glycol.

The penetration of 1,3-propanediol is shown in Table 1 below.

| | | | | | | | dry weight | |
|---|---|---|---|---|---|---|---|---|
| | | | | | | | after 103 C., | |
| | | | | | | | 24 h | |
| | | Dimensions | | | | Initial | 20 Aug. | Product |
| Sample | | Length | Width | Thickness | Volume | weight | 2024 | conc. |
| Number | Product | [cm] | [cm] | [cm] | [m²] | [g] | [g] | [%] |
| 1 | Propanediol | 10.6 | 5 | 2.5 | 0.00013 | 63.9800 | 61.54 | 100.00% |
| 2 | Propanediol | 10.6 | 5 | 2.5 | 0.00013 | 67.1800 | | 100.00% |
| 3 | Monopropylenglycol | 10.6 | 5 | 2.5 | 0.00013 | 62.6600 | 65.31 | 100.00% |
| 4 | Monopropylenglycol | 10.6 | 5 | 2.5 | 0.00013 | 64.1100 | | 100.00% |

| | | Process | | | | | |
|---|---|---|---|---|---|---|---|
| | | parameters | | | | | |
| | | [bar/min. [symbol] | Initial | Final | | | Product |
| Sample | | bar/min. [symbol] | weight | weight | Solution uptake | | uptake |
| Number | Product | bar/min.] | [g] | [g] | [g] | [kg/m [symbol] ] | [kg/m [symbol] ] |
| 1 | Propanediol | 0.1/60 [symbol] | 63.98 | 162.85 | 98.87 | 746.19 | 746.2 |
| | | 13/120; | | | | | |
| 2 | Propanediol | 0.1/60 [symbol] | 67.18 | 163.94 | 96.76 | 730.26 | 730.3 |
| | | 13/120 | | | | | |
| 3 | Monopropylenglycol | 0.1/60 [symbol] | 62.66 | 150.95 | 88.29 | 666.34 | 666.3 |
| | | 13/120 | | | | | |
| 4 | Monopropylenglycol | 0.1/60 [symbol] | 64.11 | 164.55 | 100.44 | 758.04 | 758.0 |
| | | 13/120 | | | | | |

[symbol]

indicates data missing or illegible when filed

The uptake with 1,3-propanediol as the carrier was in average 3.7% higher than the uptake of monopropylene glycol (MPG).

FIG. 1 shows that two different wood pieces that were immersed in MPG and 1,3-propanediol respectively are prone to take up different amount of solvent. In this experiment, the uptake of 1,3-propanediol was higher than MPG.

### Example 2

Based on the results of Example 1, 1,3-propanediol solvent was added to a diluted copper solution, often used for high pressure wood impregnation, with the objective to see if there was an increase uptake of the copper into wood by using a small amount of 1,3-PDO into the solution.

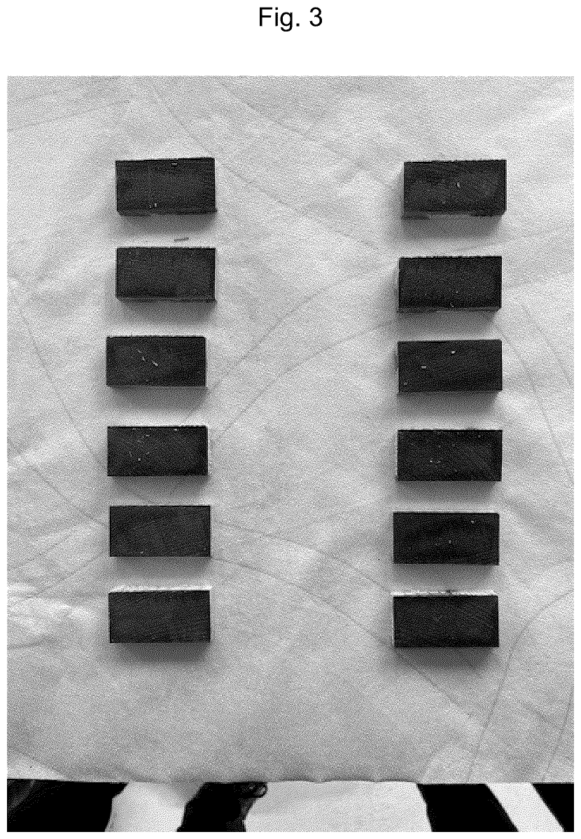

Wood was vacuum-pressure impregnated in 15% water glass solution. FIG. 3 shows six replicas on the left without 1,3-propanediol and six replicas to the right with 1 wt % 1,3-propanediol.

### Example 3

The idea is that the water glass penetrate the wood and stay in the wood, occupying spaces that otherwise water will occupy. If there is no water, there are no microorganisms and therefore an indirect way of preserving wood. Many application that contains water glass, e.g. fagade paints might have stability issues related to the water glass. If 1,3-PDO provides bulk stability, 1,3-PDO might be an interesting additive to any application that are formulated with water glass.

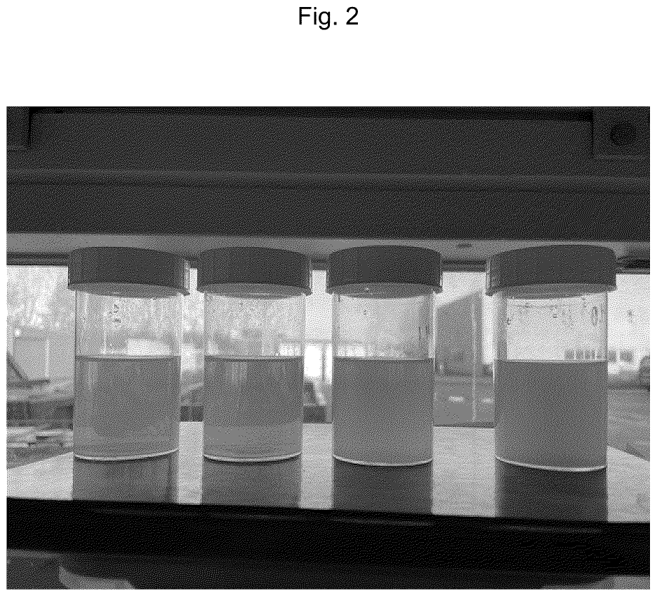

1,3-propanediol was added to 10 wt % water glass (KSiO₂) to examine stabilization of the water glass. FIG. 2 shows, from left to the right, addition of 1 wt %, 5 wt %, 10 wt %, and 0 wt % 1,3-propanediol to the water glass solution. To these solutions, a 20% solution of formic acid was added dropwise, which destabilizes the water glass solution at a specific concentration. For a 0 wt % 1,3-propanediol water glass solution, precipitation started at 2.8 g of added formic acid solution (20%). For a 50% solution of 1,3-propanediol in water, precipitation started first after 3.4 g added formic acid solution (20%). This indicates that more formic acid is needed to destabilize a water glass solution containing 1,3-propanediol as compared to water glass solution that does not contain 1,3-propanediol.

Table 2 below shows vacuum-pressure impregnation trials performed with three different concentration levels of 1,3-propanediol (all below 5 wt %). Water-based copper wood preservative in a low concentration was used. Solution uptake and estimated product retention were monitored based on weight before and after impregnation.

TABLE 2

| Concentration | Product | Improvement |
|---|---|---|
| Level of | Retention | of Product |
| 1,3-propanediol | (kg/m³) | Retention |
| Low | 11.08 | 5.0 |
| Medium | 10.80 | 2.4 |
| High | 11.57 | 9.6 |
| 0 wt % | 10.56 | N/A |

These results demonstrate that 1,3-propanediol improves the wood penetration of copper-based wood penetration formulations. Improvement of wood penetration was also observed visually (not shown).

What is claimed is:

1. A wood penetration composition comprising about 1.0 wt % to about 15 wt % 1,3-propanediol and a copper-based wood penetration formulation.

2. The wood penetration composition of claim 1, wherein the copper-based wood penetration formulation comprises copper naphthenate, copper 8-quinolinolate, acid copper chromate, alkaline copper quaternary composition containing copper oxide and a quaternary ammonium compound, bis-(N-cyclohexyldiazeniumdioxy)-copper, chromated copper arsenate, or micronized copper.

3. A method of improving penetration of a copper-based wood penetration formulation into wood comprising impregnating the wood with the wood penetration composition of claim 1.

4. A stability composition comprising about 1.0 wt % to about 15 wt % 1,3-propanediol and sodium silicate.

5. The stability composition of claim 4, wherein the sodium silicate comprises sodium metasilicate, sodium orthosilicate, sodium pyrosilicate, or a combination thereof.

6. A penetration composition comprising a 1,3-propanediol carrier and a binder.

7. The penetration composition of claim 6, wherein the binder is sodium silicate, sodium carbonate, trisodium phosphate, potassium silicate, lithium silicate, magnesium silicate, calcium silicate, ammonium silicate, or a combination thereof.

8. The penetration composition of claim 7, wherein the sodium silicate comprises sodium metasilicate, sodium orthosilicate, sodium pyrosilicate, or a combination thereof.

9. A method of improving penetration of binder into a substrate comprising impregnating the substrate with the penetration composition of claim 6.

10. The method of claim 9, wherein the substrate is wood, concrete, a building composite, or a construction composite.

11. The method of claim 10, wherein the building composite or the construction composite is composite wood, reinforced plastic, a ceramic matrix composite, or a metal matrix composite.

12. A stability composition comprising a 1,3-propanediol carrier and a binder.

13. The stability composition of claim 12, wherein the binder is sodium silicate, sodium carbonate, trisodium phosphate, potassium silicate, lithium silicate, magnesium silicate, calcium silicate, ammonium silicate, or a combination thereof.

14. The stability composition of claim 13, wherein the sodium silicate comprises sodium metasilicate, sodium orthosilicate, sodium pyrosilicate, or a combination thereof.
